(19) United States
(12) Patent Application Publication
(10) Pub. No.: US 2014/0216808 A1
(43) Pub. Date: Aug. 7, 2014

(54) AERIAL CONDUCTOR WIRE SUSPENSION CLAMP

(71) Applicants: Walter AHLISCH, (US); Roy DANE, Jackson, MI (US)

(72) Inventors: Walter AHLISCH, Edmonton (CA); Allan DANE, Edmonton (CA)

(21) Appl. No.: 14/158,022

(22) Filed: Jan. 17, 2014

Related U.S. Application Data
(60) Provisional application No. 61/753,686, filed on Jan. 17, 2013.

(51) Int. Cl. H02G 7/05

(52) U.S. Cl. CPC H02G 7/056
USPC 174/40 CC

(57) ABSTRACT

A clamp for suspending a conductor wire with a textured surface from a transmission tower includes a restraining sleeve, a housing, and a mounting tab. The restraining sleeve is made of upper and lower sleeve pieces that define a sleeve cavity to encase the conductor wire. The sleeve cavity has an internal gripping surface that intermeshes with the textured surface of the conductor wire to prevent slippage and rotation of the conductor wire relative to the sleeve cavity, without substantial compression of the conductor wire. The housing is made of a plurality of housing parts that define a housing cavity to encase restraining sleeve. The housing cavity is configured to permit rotation of the restraining sleeve, but restrict longitudinal movement of the retraining sleeve within the housing. The mounting tab is connected to the housing to permit direct or indirect connection of the clamp to a transmission tower.

### CROSS REFERENCE TO RELATED APPLICATIONS

This application claims the priority benefit of U.S. Provisional Application No. 61/753,686 filed on Jan. 17, 2013 entitled “Aerial Conductor Wire Suspension Clamp”, the contents of which are incorporated herein by reference.

### FIELD OF THE INVENTION

The present invention relates to a suspension clamp for aerial conductor wire in power transmission lines.

### BACKGROUND OF INVENTION

Conductor wire galloping is a phenomenon observed in aerial transmission lines when high winds blow across the conductor wires. The conductor wires oscillate at a low frequency, typically 0.5 to 1 Hz, and may reach peak to peak amplitudes of 10 feet or more. Conductor wire galloping can damage transmission towers and take down power transmission lines.

Conventional suspension clamps and spacer dampers clamp onto the conductor wire and suspend it from tower cross arms in such a manner that both longitudinal movement and rotation of the conductor wire is restricted. It is believed that conductor wire galloping may be reduced or eliminated if the suspension clamp would allow rotational movement while still preventing longitudinal movement of the conductor wire. Therefore, there is a need in the art for a suspension clamp which permits rotation of the conductor wire within the clamp while restricting longitudinal movement.

Canadian Patent No. 1,161,913 (U.S. Pat. No. 4,381,422) discloses a spacer-damper which includes a vice enclosing a roller bearing or sleeve bearing within which the conductor wire rests. In this apparatus, the conductor wire is not firmly fixed within the spacer-damper and a strong longitudinal force may cause the conductor wire to slip within the device. It is necessary to introduce a durable grease into the cavity containing the roller bearing and to provide a gasket seal to protect against the penetration of dust, water or the like. If any portion of the roller bearing or sleeve enclosing the wire is made of a ferromagnetic material such as steel, two additional disadvantages result. First, current in the conducting wire will produce considerable heat in the roller bearing races which may cause its premature failure. Second, the ingress of water may cause corrosion of the aluminium conductor wire as a result of its contact with the steel bearing race.

U.K. Patent No. 1,320,893 discloses a similar spacer-damper in which the conductor wire is clamped within a roller bearing by a resilient rubber member. This spacer also permits rotation of the conductor wire while resisting longitudinal movement. Again, a strong longitudinal force will likely displace the conductor wire within the spacer because of the tenuous hold the spacer has on the conductor wire through the resilient rubber member. Also, the bearings may overheat and fail as a result of current being conducted through the conductor wire and the ingress of dust particles. It is also a concern with this prior art using roller bearings that the bearing races must be constructed in split halves in order to be placed around the wire, which adds complexity and expense to the device.

U.S. Pat. No. 6,528,721 discloses an aerial conductor wire suspension clamp in which a restraining sleeve is bonded to the conductor wire, and placed between two split sleeves within a clamshell housing. The suspension clamp permits relative rotation of the conductor wire and the housing, by allowing rotation of the restraining sleeve within the housing. An adequate bond between the restraining sleeve and the conductor wire must be achieved to resist “pull out” failure of the conductor wire. However, bonding techniques such as press-fitting by hydraulic pressing or implosion joining may damage the conductor wire by crushing of the composite materials such as ceramic, glass and plastic fibre that may be used as insulators and reinforcement in modern conductor wires. The press-fitting technique should ideally be performed by skilled personnel working in controlled conditions conducive to quality control, but this is not always practicable during in situ installation on transmission towers. Further, the restraining sleeve may need to have considerable length to develop bond stress with the conductor wire. However, increasing the length of the restraining sleeve also increases the length, and thus weight, of the suspension clamp as a whole. Increased size and weight of the suspension clamp places increased structural demands on the connection of the clamp to the transmission tower and makes the suspension clamp more difficult to handle and install. Further, the restraining sleeve taper at the ends of the sleeve may introduce stress concentrations into the conductor wire, which may reduce the breaking strength of the conductor wire and exacerbate stress corrosion phenomena. As well, the end of the restraining sleeve and its bond with the conductor wire may be damaged with use insofar as the end of the restraining sleeve also serves as a bearing surface to restrict the longitudinal movement of the restraining sleeve within the housing.

Therefore, there is a need in the art for a suspension clamp which mitigates the problems in the prior art.

### SUMMARY OF INVENTION

In one aspect, the present invention comprises a clamp for suspending an aerial conductor wire from a transmission tower. The clamp comprises a restraining sleeve, a housing, and a mounting tab. The restraining sleeve comprises at least two sleeve pieces which may be mated and fastened together so as to define a substantially cylindrical sleeve cavity for gripping the conductor wire. The restraining sleeve has two sleeve openings on opposing ends of the sleeve cavity for permitting the conductor wire to pass therethrough. In one embodiment, the sleeve cavity may have an internal gripping surface textured to engage the textured surface of the conductor wire segment when encased within the sleeve cavity so as to resist longitudinal slippage and rotation of the conductor wire segment relative to the restraining sleeve. The housing comprises at least two housing pieces which may be mated and fastened together to define a housing cavity for encasing the restraining sleeve and two housing openings on opposing ends of the housing cavity for permitting the conductor wire to pass therethrough. The housing cavity is configured to permit rotation of but restrict longitudinal movement of the restraining sleeve within the housing. The mounting tab is connected to the housing for directly or indirectly attaching the clamp to the transmission tower.

In one embodiment of the clamp, the housing defines an internal groove and the restraining sleeve comprises an external transverse collar. The groove is complementarily contoured to receive the collar to restrict longitudinal movement of the restraining sleeve within the housing. The collar may define at least one sleeve connector aperture spanning through at least two sleeve pieces to receive a connector therethrough. In one embodiment, the collar and groove completely encircle the restraining sleeve.

In one embodiment of the clamp, the internal gripping surface is textured to define a contoured surface that is complementary to a helically twisted surface of a conductor.

In one embodiment of the clamp, the housing comprises two end plates to define the housing openings at opposing ends of the housing cavity, to restrict the longitudinal movement of the restraining sleeve within the housing.

In one embodiment of the clamp, the housing further comprises a downwardly curved conductor support extending from beneath one of the housing openings for supporting the conductor wire segment at the housing opening. The conductor support may be downwardly curved to match the segment of a catenary curve.

In one embodiment of the clamp, the housing defines at least one drainage aperture extending from the housing cavity to the exterior surface of the housing. The housing cavity may be contoured to direct fluid towards the drainage aperture.

In one embodiment of the clamp, the restraining sleeve is made of aluminium. In one embodiment of the clamp, an exterior surface of the restraining sleeve, or an interior surface of the housing cavity, or both are coated with a low-friction material, such as polytetrafluoroethylene.

In one embodiment of the clamp, the clamp further comprises a collar seal having an inner diameter closely matching the diameter of the conductor wire and permitting the conductor wire to pass therethrough. The collar is disposed in the housing cavity between a sleeve opening and a housing opening so as to prevent contaminants from entering the sleeve cavity.

### BRIEF DESCRIPTION OF DRAWINGS

The invention will now be described by way of an exemplary embodiment with reference to the accompanying simplified, diagrammatic, not-to-scale drawings. In the drawings:

FIG. 1 is an exploded perspective view of one embodiment of the suspension clamp of the present invention.

FIG. 2 is a perspective view of the restraining sleeve of one embodiment of the suspension clamp of the present invention.

FIG. 3 is a perspective view of a sleeve piece of one embodiment of the suspension clamp of the present invention.

FIG. 4 is a perspective view of the housing of one embodiment of the suspension clamp of the present invention.

FIG. 5 is a cross-sectional view of the housing of one embodiment of the suspension clamp of the present invention along its longitudinal centre line.

### DETAILED DESCRIPTION OF EMBODIMENTS OF THE INVENTION

When describing the present invention, all terms not defined herein have their common art recognized meanings. To the extent that the following description is of a specific embodiment of invention, it is intended to be illustrative only, and not limiting of the claimed invention. The following description is intended to cover all alternatives, modifications and equivalents that are included in the spirit and scope of the invention, as defined in the appended claims.

The present invention relates to a clamp for suspending an aerial conductor wire with a textured surface from a transmission tower.

As used herein, the term “longitudinal” means a direction collinear with the path defined by a conductor wire. The term “transverse” means a direction perpendicular to the longitudinal axis.

As used herein, the term “textured surface” in reference to the external surface of a conductor wire refers to any surface that has contours that can be resolved into components that are parallel and perpendicular to the longitudinal direction of the conductor wire. One non-limiting example of a textured surface is a “helically twisted surface” resulting from the technique of constructing conductor wires in the recognized common art method of laying conductor strands about a central core in a specified pattern, in one or more layers, and helically twisting the strands to produce a rope-like conductor wire. The resultant conductor wire has an external surface characterized by a helical lay of strands, with troughs where the cross-section of one exposed strand abuts the cross-section of another exposed strand. As a result of the helical lay of the strands, the exposed portions of the strands have ridges that can be resolved into components that are parallel and perpendicular to the longitudinal direction of the conductor wire. Conductor wires with a “helically twisted surface” include what is referred to in the art as “compact” conductor wire wherein the originally circular cross-sections of the external strands are deformed by compression or die forming during manufacture, to reduce the overall diameter of the conductor wire.

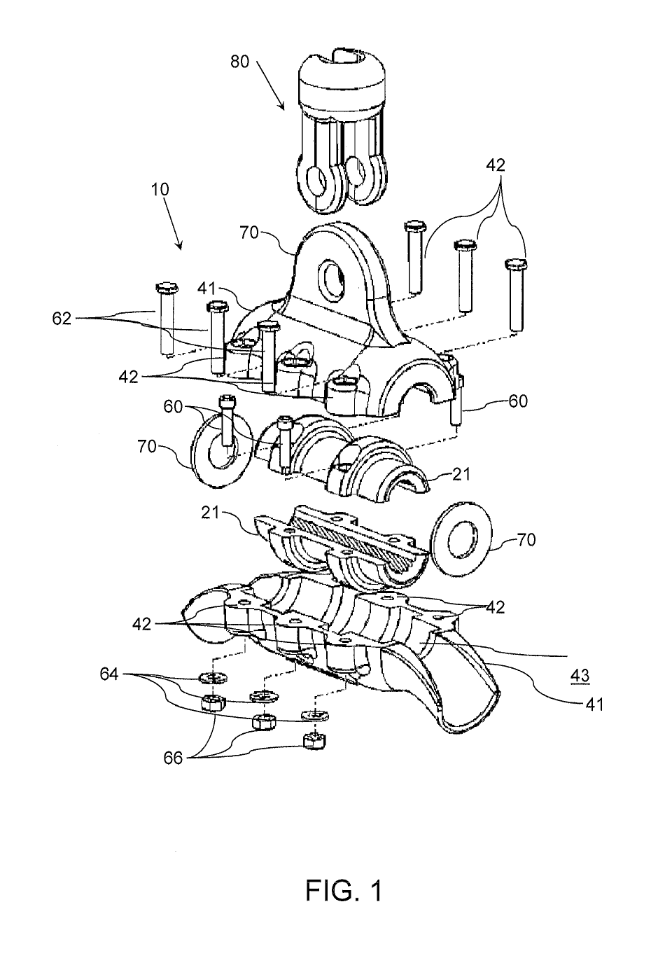

FIG. 1 provides an exploded perspective view of one embodiment of the suspension clamp of the present invention. In general, the suspension clamp (10) comprises a restraining sleeve (20) comprising upper and lower sleeve pieces (21), which mate to form a member which is preferably substantially cylindrical, and a housing (40) comprising upper and lower housing pieces (41) and a mounting tab (70).

The mounting tab (70) forms part of, or is connected to, the housing (40) for directly or indirectly attaching the clamp to the transmission tower. In one embodiment, as shown in FIGS. 1, 4 and 5, the mounting tab (70) is formed monolithically with one of the housing pieces (41) of the housing (40). The mounting tab (70) defines a mounting tab aperture (72) for receiving a pin, which retains the mounting tab (70) in a clevis (80), which is in turn connected to a transmission tower.

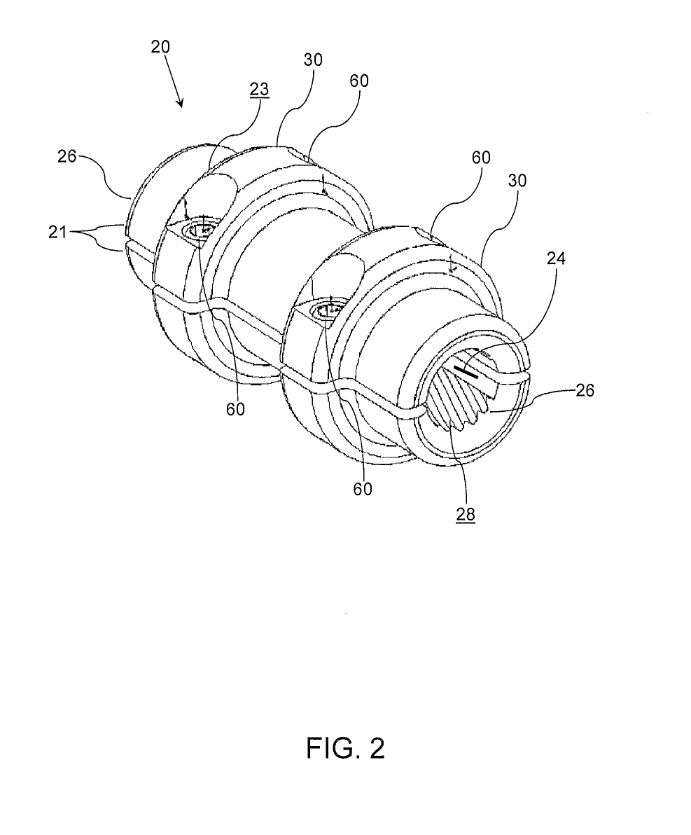

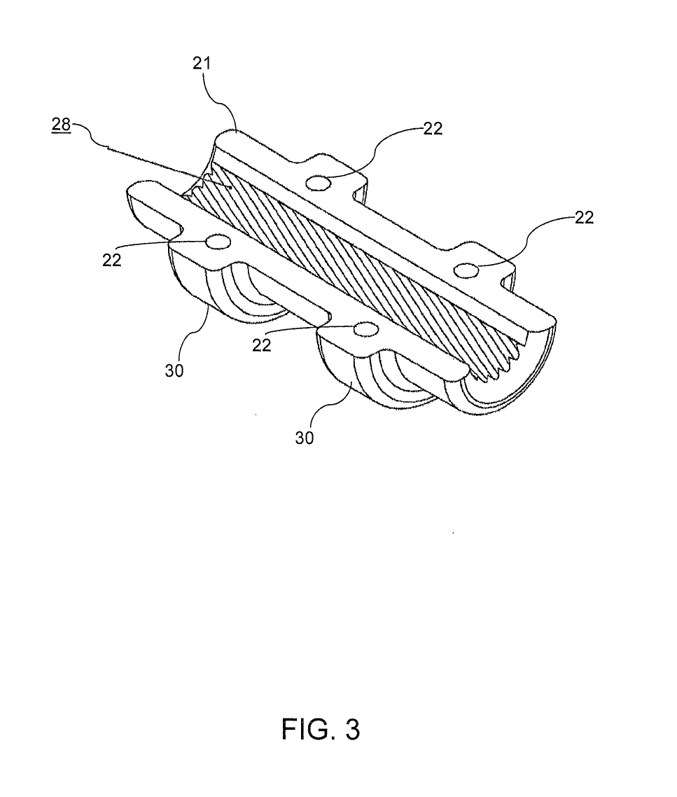

In one embodiment, as shown in FIG. 2, the upper and lower sleeve pieces are semi-cylindrical, as shown in FIG. 3, The number and symmetry of the sleeve pieces (21) is not critical, but it will be appreciated that using two symmetrical sleeve pieces (21) minimizes the complexity of manufacturing the restraining sleeve (20).

The upper and lower sleeve pieces (21) mate together to define a cylindrical sleeve cavity (24) open at both ends (26). The diameter of the sleeve cavity (24) closely matches or is slightly smaller than the diameter of the conductor wire such that a conductor wire segment may be encased within the sleeve cavity (24) and pass through the sleeve openings (26). The conductor wire must be restrained against longitudinal movement within the sleeve cavity, without being substantially compressed by the sleeve pieces (21) so as to cause damage to the conductor wire. The sleeve pieces (21) may be slightly bevelled or chamfered around the sleeve openings (26), as is shown in FIGS. 2 and 3.

Once the two sleeve pieces (21) are mated together to encase the conductor wire segment within the sleeve cavity (24), the sleeve pieces (21) can be connected together by any suitable means. In one embodiment, as shown in FIGS. 2 and 3, the restraining sleeve (20) defines a plurality of symmetrically distributed, internally threaded, sleeve connector apertures (22) that span through the two sleeve pieces (21) to receive threaded sleeve bolts (60).

The sleeve pieces (21) are preferably proportioned and made of a material having sufficient strength and hardness to sufficiently grip the conductor wire, but also to limit the amount of compression against the conductor wire segment, even if the sleeve bolts (60) are over-tightened. In this manner, the conductor wire segment is protected against crushing by the sleeve pieces (21). In one embodiment, the sleeve pieces (21) are cast-formed from aluminium alloy. However, in alternative embodiments, the sleeve may comprise a sufficiently hard plastic, rubber or urethane material. In one embodiment, the outer surface (23) of the restraining sleeve (20) is coated with a low-friction material such as polytetrafluoroethylene to facilitate rotation of the restraining sleeve (20) within the housing (40).

In one embodiment, the sleeve cavity (24) has a pre-formed internal gripping surface (28) textured to engage the textured surface of the conductor wire segment when encased within the sleeve cavity (24) so as to resist longitudinal slippage and rotation of the conductor wire segment relative to the restraining sleeve (20). In one embodiment, as shown in FIG. 3, the internal gripping surface (28) is textured to define a contoured surface that is complementary to the surface of the conductor wire segment, which is typically formed from helically twisted strands. The contoured surface is complementary to a helically twisted surface in the sense that the contoured surface has peaks and troughs that coincide, in an interlocking manner, with troughs and peaks, respectively, of the surface of the conductor wire comprising helically twisted strands. The internal gripping surface (28) should be proportioned, textured and made of a material of sufficient strength and stiffness to develop sufficient resistance against longitudinal forces due to the anticipated galloping of the conductor wire. In this manner, the required amount of compression that the sleeve (20) imparts on the conductor wire may be reduced compared to the levels of compression that would otherwise be required in the absence of the textured internal gripping surface.

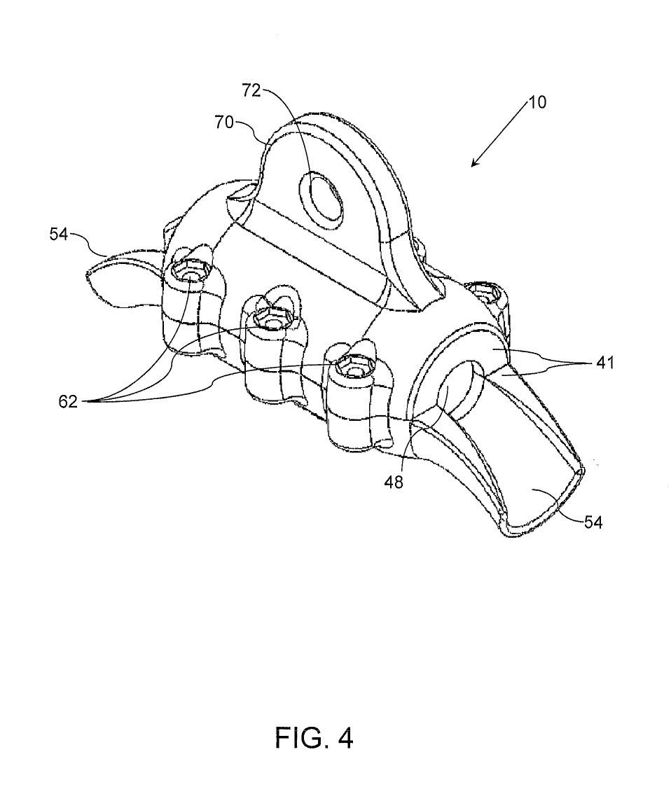

In one embodiment, as shown in FIG. 4, the housing (40) has top and bottom housing pieces (41). The number of the housing pieces (41) is not critical, but it will be appreciated that using two housing pieces (41) minimizes the complexity of manufacturing the housing (40).

The two housing pieces (41) can be mated together to define a housing cavity (46) with two housing openings (48) on either side of the housing cavity (46). The housing openings (48) are dimensioned to permit the conductor wire segment to pass through the housing openings (48) and to allow clearance for rotation of the conductor wire segment.

Once the two housing pieces (41) are mated together to encase the restraining sleeve (20), the housing pieces (41) are connected together using any means in the common art. In one embodiment, as shown in FIGS. 1 and 4, the housing sleeves (41) define a plurality of symmetrically distributed, housing connector apertures (42) that span through the two housing pieces (41) to receive threaded housing bolts (62), which are secured with housing washers (64) and housing nuts (66).

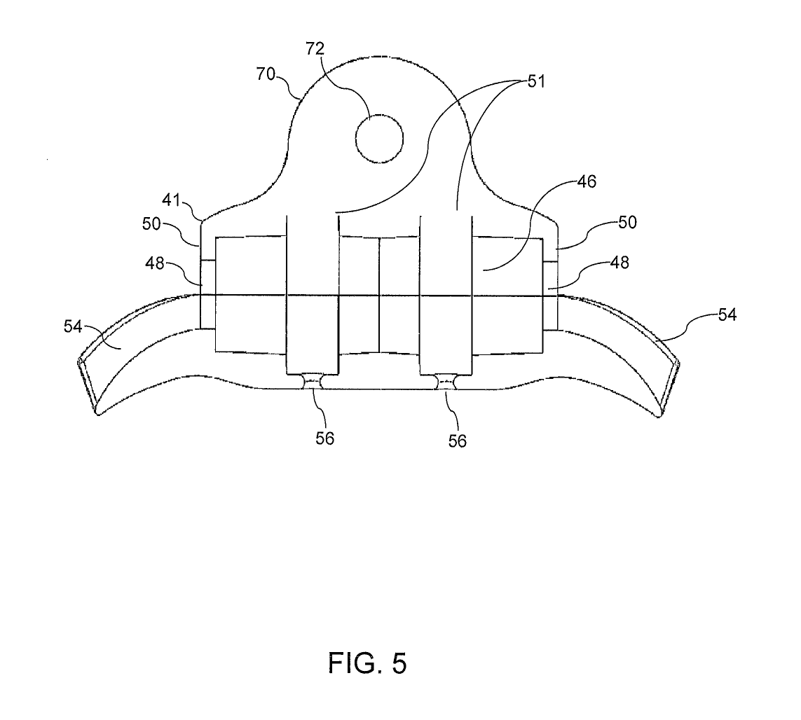

The housing cavity (46) is complementarily contoured to the restraining sleeve (20) so as to encase the restraining sleeve (20) and restrict its longitudinal movement, while permitting rotation of the restraining sleeve (20). In one embodiment, as shown in FIG. 5, the housing cavity (46) comprises two end plates (50) at opposing ends of the housing cavity (46), which in addition to defining the housing openings (48), also restrict the longitudinal movement of the restraining sleeve (20) within the housing (40). In one embodiment, as shown in FIG. 5, the housing cavity (46) defines internal transverse grooves (51) formed on an intermediate portion of the housing cavity, while the restraining sleeve (20) comprises external transverse collars (30) formed on an intermediate portion of the restraining sleeve (20). The collars (30) may be attached to or be an integral part of the restraining sleeve (20). The grooves (51) receive the collars (30) and are configured to permit rotation of the collars (30) therein, but the sidewalls of the grooves (51) interfere with the sidewalls of the collars (30) to restrict longitudinal movement of the restraining sleeve (20) within the housing (40). In this manner, the bearing stress on the ends of the restraining sleeve (20) may be reduced or avoided when the housing (40) restrains the longitudinal movement of the restraining sleeve within the housing (40). The collars (30) also provide a thickened portion of the sleeve piece (21) for defining the sleeve connector apertures (22). Persons skilled in the art will appreciate that other complementary configurations of the housing cavity (46) and the restraining sleeve (20) may be used to achieve the intended effect of permitting rotation of the restraining sleeve (20) while restricting longitudinal movement of the restraining sleeve (20) within the housing (40).

In one embodiment, the grooves (51) and collars (30) completely encircle the restraining sleeve (20).

The housing pieces (41) should be proportioned to and made of a material of sufficient strength and stiffness to resist the static and dynamic forces imparted by the restraining sleeve (20). In one embodiment, the housing pieces (41) are cast-formed from aluminium alloy. In one embodiment, the inner surface (43) of the housing (40) is coated with a low-friction material such as polytetrafluoroethylene to facilitate rotation of the restraining sleeve (20) within the housing (40).

Transmission towers are often spaced apart by several hundreds of meters, which results in a significant mass of conductor wire being suspended by the suspension clamp. Moreover, the conductor wire may have a catenary profile between successive transmission towers, which means that the conductor wire has a downward inclination upon exiting the sleeve opening (26) and the housing opening (48). As will be appreciated by persons skilled in the art, stress concentrations may be induced in the vicinity of the conductor wire resting downwardly against the bottom edges of the sleeve openings (26) and housing openings (48). These stress concentrations may damage the conductor wire, reduce its strength or exacerbate stress corrosion phenomena. In one embodiment of the suspension clamp, as shown in FIGS. 1, 4 and 5, this problem is mitigated by providing conductor supports (54) extending from beneath the housing openings (48). The purpose of the curvature of the conductor supports (54) is to match the curvature of the conductor wire in its at-rest position so as to more evenly distribute the upward reactive forces imparted by the housing openings (48) and the sleeve openings (26) on the conductor wire. In a preferred embodiment, the conductor supports (54) are downwardly curved to match the segment of a catenary curve.

When the suspension clamp (10) is installed in the external environment, water may enter the housing cavity (46) in the form of precipitation or condensation of atmospheric humidity. Water retained in the housing cavity (46) might interfere with the rotation of the restraining sleeve (20) within the housing (40), or result in corrosion of the housing pieces (41), housing bolts (62), the sleeve bolts (60), and the housing bolts (62). In one embodiment of the suspension clamp, as shown in FIG. 5, this problem is mitigated by providing drainage apertures (56) extending from the housing cavity (46) to the exterior surface of the housing (40) to permit water to exit the housing cavity (46). Moreover, the bottom surfaces of the housing cavity (46) are slightly inclined to direct liquid towards the drainage apertures (56).

When the suspension clamp (10) is installed in the external environment, contaminants such as water and blown dust and sand may enter the sleeve cavity (24). Such contaminants may erode or foul the internal gripping surface (28) or lead to corrosion of the internal gripping surface (28), thereby reducing its ability to resist relative movement of the conductor wire. In one embodiment of the suspension clamp, as shown in FIG. 5, this problem is mitigated by providing a pair of collar seals (70) disposed in the housing cavity (46) between the sleeve openings (26) and the housing openings (48). The purpose of the collar seals (70) is to provide a contaminant barrier for the sleeve cavity (46). The collar seals (70) have an inner diameter that closely matches the diameter of the conductor wire so as form a friction fit around the conductor wire. The collar seals (70) have an outer diameter less than the diameter of the housing cavity (46) where the collar seals (70) are situated, so that the collar seals (70) can freely rotate within the housing cavity (46). The collars may be made of any suitable material, including polyvinyl chloride plastic.

As will be apparent to those skilled in the art, various modifications, adaptations and variations of the foregoing specific disclosure can be made without departing from the scope of the invention claimed herein.

What is claimed is:

1. A clamp for suspending an aerial conductor wire with a textured surface from a transmission tower, the clamp comprising:
(a) a restraining sleeve comprising a pair of sleeve pieces which are mated and fastened together to define a cylindrical open-ended sleeve cavity for gripping the conductor wire, wherein the sleeve comprises at least one transverse collar;
(b) a housing comprising upper and lower housing pieces which may be mated and fastened together to define a housing cavity for encasing the restraining sleeve and two housing openings on opposing ends of the housing cavity for permitting the conductor wire to pass therethrough, wherein the housing cavity defines at least one groove which receives the sleeve collar to permit rotation of but restrict longitudinal movement of the restraining sleeve within the housing;
(c) a mounting tab connected to the housing for directly or indirectly attaching the clamp to the transmission tower.

2. The clamp of claim 1 the sleeve cavity comprises a pre-formed internal gripping surface textured to engage the textured surface of the conductor wire segment when encased within the sleeve cavity so as to resist longitudinal slippage and rotation of the conductor wire segment relative to the restraining sleeve.

3. The clamp of claim 2 wherein the internal gripping surface is textured to define a contoured surface that is complementary to a conductor wire surface formed by helically twisted strands.

4. The clamp of claim 1 wherein the housing defines at least two internal grooves, and wherein the restraining sleeve comprises at least two transverse collars.

5. The clamp of claim 1 wherein the transverse collar defines at least one sleeve connector aperture spanning through at least two sleeve pieces to receive a connector therethrough.

6. The clamp of claim 1 wherein the housing further comprises a downwardly curved conductor support extending from beneath one of the housing openings for supporting the conductor wire segment at the housing opening.

7. The clamp of claim 6 wherein the conductor support is downwardly curved to match the segment of a catenary curve.

8. The clamp of claim 1 wherein the housing defines at least one drainage aperture extending from the housing cavity to the exterior surface of the housing.

9. The clamp of claim 8 wherein the housing cavity is contoured to direct fluid towards the drainage aperture.

10. The claim of claim 1 wherein the restraining sleeve is made of aluminum.

11. The clamp of claim 1 wherein the exterior surface of the restraining sleeve, or the inner surface of the housing cavity, or both, is coated with a low-friction material.

12. The clamp of claim 11 wherein the low-friction material is polytetrafluoroethylene.

13. The clamp of claim 1 further comprising a collar seal having an inner diameter closely matching the diameter of the conductor wire and permitting the conductor wire to pass therethrough, the collar disposed in the housing cavity between a sleeve opening and a housing opening so as to prevent contaminants from entering the sleeve cavity.

14. The clamp of claim 1 wherein the pair of sleeve pieces are symmetrical and bolted together.

15. The clamp of claim 1 wherein the sleeve pieces comprise aluminium.

15. The clamp of claim 1 wherein the at least one groove and the at least one collar completely encircle the restraining sleeve.
